(19) United States
(12) Patent Application Publication
(10) Pub. No.: US 2007/0165602 A1
(43) Pub. Date: Jul. 19, 2007

(54) Voice mail device and voice mail communication method

(76) Inventors: Hiroshi Asada, Tokyo (JP); Shuichi Sato, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/589,564

(22) PCT Filed: Jan. 13, 2005
(86) PCT No.: PCT/JP05/00271

§ 371 Date: Aug. 16, 2006

(30) Foreign Application Priority Data
Feb. 27, 2004 (JP) 2004-053633

(51) Int. Cl. H04L 12/66

(52) U.S. Cl. 370/352

(57) ABSTRACT

A voice mail device includes a packet storing section which stores a received audio packet including audio data in a first encoding format. Therefore, the received audio packet is stored as it is without undergoing any transcoding, so that it is possible to reduce a need for transcoding upon receipt of the audio packet, and as a result, reduce a need for an audio CODEC.

### TECHNICAL FIELD

The present invention relates to a voice mail device and a voice mail communication method that enable communication between telephone terminals.

### BACKGROUND

In a telephone system, voice mail is sometimes handled. In this case, voice such as a message is recorded in a voice mail device and is later played back by a telephone terminal. Here, Voice Over Internet Protocol (VoIP) is increasingly adopted in telephone systems, and transmission/receipt of audio data in the form of an IP packet is coming into practice. Such a telephone system adopting VoIP possibly uses audio data in audio compression formats of various types. Therefore, audio data is taken out from an audio packet received from a telephone terminal and is converted to analog data or PCM for recording. There is disclosed an art in which a normal telephone terminal is notified of the presence of a voice mail message via a gateway and the voice mail message can be listened to through the normal telephone terminal (see Patent Document 1).

Patent Document 1: JP-A 2001-309040 (KOKAI)

### DISCLOSURE OF THE INVENTION

Transcoding requires an expensive audio CODEC (coder-decoder) using a dedicated DSP (Digital Signal Processor) or the like. Further, it is necessary to prepare the audio CODECs commensurate with the number of lines for reception. This is for preventing the decrease in the number of available lines which is caused when the audio CODEC is used exclusively for transcoding (recording). As described above, in order to realize a voice mail device that enables nonblocking recording of all incoming calls in VoIP communication, it has been necessary to prepare audio CODECs of various types using an expensive DSP or like so as to be commensurate with the necessary number of lines (channels). In view of the above, it is an object of the present invention to provide a voice mail device and a voice mail communication method that do not require any audio CODEC or that permits a reduced transcoding ability thereof.

In order to achieve the object stated above, a voice mail device according to one of the aspects of the present invention includes: a receiving section which receives from a first telephone terminal an audio packet including audio data in a first encoding format; a packet storing section which stores the audio packet including the audio data in the first encoding format received by the receiving section; and a transmitting section which transmits to a second telephone terminal the audio packet stored in the packet storing section.

The voice mail device has the packet storing section which stores the received audio packet including the audio data in the first encoding format. Therefore, the received audio packet is stored as it is without undergoing any transcoding, so that transcoding upon reception, and as a result, an audio CODEC becomes unnecessary.

(1) Here, the voice mail device may further include an encoding format determining section which communicates with the second telephone terminal to determine an encoding format of audio data, and the transmitting section may transmit to the second telephone terminal the audio packet stored in the packet storing section when the determined encoding format is the first encoding format.

When the stored audio data is to be transmitted, the encoding format is determined based on the communication with a telephone terminal that is a desired destination of the transmission (the second telephone terminal). When the determined encoding format is the same as the encoding format of the stored audio data, the stored audio data (audio packet) may be transmitted as it is. For example, when the telephone terminal as the desired destination of the transmission is adapted to a plurality of encoding formats, the matching possibility of the encoding format of the stored audio data is high.

(2) The voice mail device may further include: an encoding format determining section which communicates with the second telephone terminal to determine an encoding format of audio data; and a transcoding section which transcodes the audio data in the first encoding format included in the audio packet stored in the packet storing section, based on the determination by the encoding format determining section.

When the stored audio data is to be transmitted, the encoding format is determined based on the communication with a telephone terminal as a desired destination of the transmission (the second telephone terminal). When the determined encoding format is different from the encoding format of the stored audio data, the stored audio data is transcoded for transmission. Since an amount of data transmitted by the voice mail device side can be controlled at the transmission time, the transcoding ability at this time does not necessarily need to be commensurate with the number of lines. Specifically, if transcoding is executed at the transmission time and not at the reception time, a reduced transcoding ability of the transcoding section (for example, an audio CODEC) is permissible.

As an example, an encoded service voice is prepared and the service voice is transmitted to the second telephone terminal prior to the transmission of the stored audio data (a message voice). The message voice is encoded during the transmission of the service voice (a kind of backgrounding) and the encoded message voice is transmitted after the transmission of the service voice is finished. In this way, it is possible to offer a continuous service to the second telephone terminal and to have a sufficient time for encoding the message voice. As described above, on a user side, it is possible to receive a continuous service even when the transcoding speed does not respond to the transmission speed (even when real-time processing is not possible).

Here, the voice mail device may further include: a transcoded audio storing section which stores the audio data transcoded by the transcoding section; a packet converting section which converts the transcoded audio data stored in the transcoded audio storing section to an audio packet; and a packet transmitting section which transmits to the second telephone terminal the audio packet resulting from the conversion by the packet converting section. The audio data once transcoded is stored, so that it is not necessary to transcode the same audio data again when it is to be transmitted, which realizes more efficient processing.

(3) The voice mail device may further include: a first audio data storing section which stores the audio data in the first encoding format; a second audio data storing section which stores the audio data in a second encoding format; an encoding format determining section which communicates with the second telephone terminal to determine an encoding format of audio data; an audio data selecting section which selects the audio data stored in one of the first and second audio data storing sections based on the determination by the encoding format determining section; a packet converting section which converts the audio data selected by the audio data selecting section to an audio packet; and a packet transmitting section which transmits the audio packet resulting from the conversion by the packet converting section.

The audio data in the first encoding format included in the received audio packet is stored in the first audio data storing section and the audio data in the second encoding format is stored in the second audio data storing section, and at the transmission time, the audio data stored in one of these first and second audio data storing sections is selected for transmission. The audio data in the plural encoding formats are thus prepared, so that quick response to a transmission request is possible, which is especially suitable for transmitting a service voice to a telephone terminal from the voice mail device. The audio data in the first encoding format included in the received audio packet is once stored in the first audio data storing section and is subjected to data conversion later, which enables quick reception of the audio packet (nonblocking).

Here, the voice mail device may further include a packet receiving section which receives a first audio packet including the audio data in the first encoding format and a second audio packet including the audio data in the second encoding format, and the first and second audio data storing sections may store the first and second audio data included in the first and second audio packets received by the packet receiving section. The first and second audio data included in the first and second audio packets received by the packet receiving section can be stored in the first and second audio data storing sections.
The packet receiving section may receive the first and second audio packets transmitted from a telephone terminal. The service voice can be inputted, using the telephone terminal.
The packet receiving section may receive first and second audio packets originating in audio data recorded in a storage medium. The service voice can be inputted, using the storage medium.

### BRIEF DESCRIPTION OF THE DRAWINGS

FIG. 1 is a block diagram showing a telephone system according to an embodiment of the present invention.

FIG. 2 is a view showing au audio packet management table.

FIG. 3 is a flowchart showing an example of the operation procedure of a telephone system.

### BEST MODE FOR IMPLEMENTING THE INVENTION

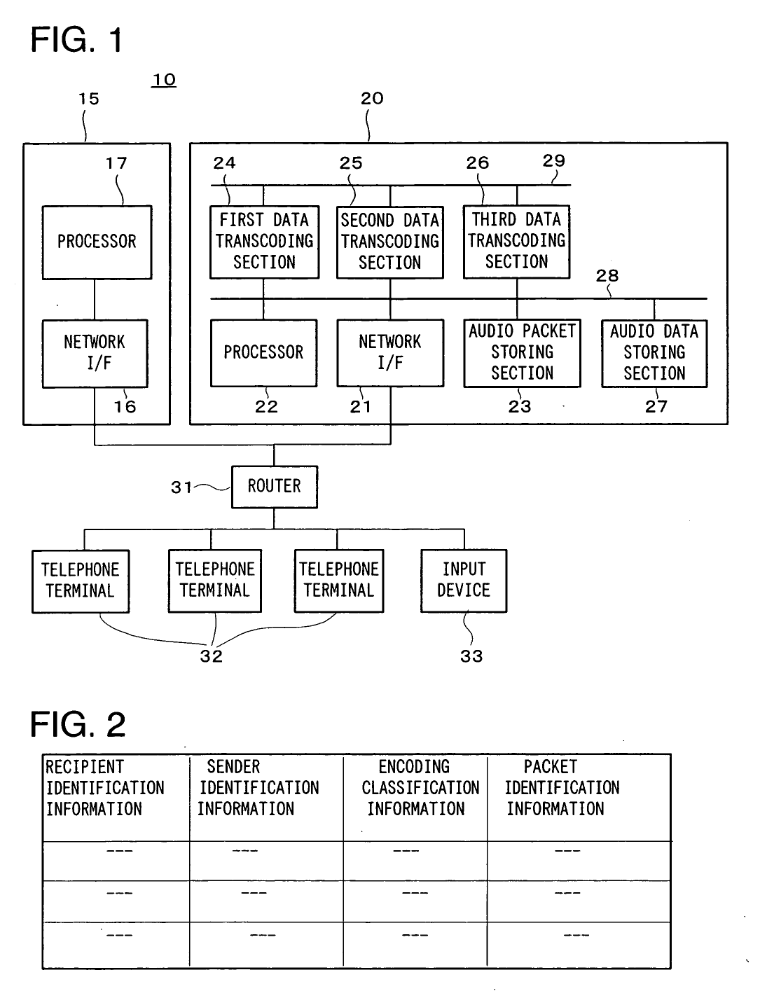

Hereinafter, an embodiment of the present invention will be described in detail with reference to the drawings. FIG. 1 is a block diagram showing a telephone system 10 according to an embodiment of the present invention. The telephone system 10 has an IP telephone exchange 15, a voice mail device 20, a router 31, telephone terminals 32, and an input device 33, and it is a system that enables calls among the telephone terminals 32 by means of IP packets including audio data.

In this telephone system 10, the IP telephone exchange 15 and the voice mail device 20 are distributedly located by way of LAN (Local Area Network). Alternatively, the IP telephone exchange 15 and the voice mail device 20 can be integrally configured. Incidentally, FIG. 1 shows the state in which the router 31 is directly connected to the telephone terminals 32 and the input device 33, but some other network (for example, the Internet) may intervene therebetween.

The IP telephone exchange 15 has a network I/F (interface) 16 and a processor 17, and it controls via the router 31 communication (calls) between the telephone terminals 32 and between the telephone terminals 32 and the voice mail device 20. The network I/F 16 is a means of communication enabling communication of the IP telephone exchange 15 with the voice mail device 20 and the telephone terminals 32 via the router 31. The processor 17 is a so-called central processing unit (CPU) and it controls the whole telephone exchange 15. The processor 17 performs processing, for instance, for controlling communication (calls) between the telephone terminals 32 and between the telephone terminals 32 and the voice mail device 20. Incidentally, it is possible to use a network processor in which the network I/F 16 and the processor 17 are integrally configured.

The voice mail device 20 has a network I/F (interface) 21, a processor 22, an audio packet storing section 23, first to third data transcoding sections 24 to 26, and an audio data storing section 27, and it transmits/receives audio packets to/from the telephone terminals 32 via the router 31. Its constituent elements will be detailed later.

The router 31 is an interconnecting device that interconnects the voice mail device 20 and the telephone terminals 32 for communication. Incidentally, a switch is usable in place of the router 31. The telephone terminals 32 exchange audio packets with the voice mail device 20. When voices are inputted thereto, the telephone terminals 32 convert the inputted voices to audio packets, which are transmitted to the voice mail device 20. The telephone terminals 32 also receive audio packets from the voice mail device 20 to convert them to audio outputs. The input device 33 is a device that converts audio data, which are inputted thereto from storage media such as CD (CD-R, CD-RW, and the like), DVD, and smart media, to audio packets and transmits the audio packets to the voice mail device 20.

(Details of the Voice Mail Device 20)

Hereinafter, the constituent elements of the voice mail device 20 will be described in detail. The network I/F 21 is a means of communication that enables via the router 31 communication between the voice mail device 20 and the telephone terminals 32, and it functions as a receiving section, a transmitting section, and a packet receiving section. The network I/F 21 transmits/receives audio data, using an IP packet. The IP packet used here is an audio packet including a header (for example, an RTP header) and encoded audio data. G711, G729, G723.1 or the like is usable as an audio data encoding format. Information according to a communication protocol is added to this IP packet (audio packet) when necessary. For example, in communication based on UDP (User Datagram Protocol), this IP packet functions as a UDP packet.

The processor 22 is a so-called central processing unit (CPU), and it controls the whole voice mail device 20. For example, it performs processing for generating an audio packet by adding an RTP header based on the classification of audio data, processing for having this audio packet function as a UDP packet, and so on. The processor 22 also functions as an encoding format determining section which communicates with the telephone terminal 32 to determine an encoding format. Incidentally, a network processor in which the network I/F 21 and the processor 22 are integrally configured is usable.

The audio packet storing section 23 is constituted of a storage means such as a hard disk and a semiconductor memory, and it stores the audio packet received by the network I/F 21. At this time, the received audio packet is stored in the audio packet storing section 23 as it is. In other words, the audio data in the received audio packets do not undergo any conversion of the encoding format thereof. A need for the conversion of the encoding format of the audio data upon receipt of the audio packet is eliminated, and hence the transcoding ability of the first, second, and third data transcoding sections 24 to 26 need not be commensurate with the number of lines, thereby permitting reduction in the number or the like of expensive DSPs.

For example, when an audio packet transmitted from the telephone terminal 32 and received by the network I/F 21 includes UDP, an RTP header, and audio data in G729 format, the audio packet including the RPT header and the audio data in G729 format is stored in the audio packet storing section 23. Note that UDP data can be removed by the processor 22.

The audio packet stored in the audio packet storing section 23 is transmitted from the network I/F 21 without undergoing any transcoding when the encoding format thereof matches that of the telephone terminal 32 that is a desired destination of the transmission. For example, when an audio packet including an RPT header and audio data in G729 format is stored in the audio packet storing section 23, an audio packet including UDP, the RTP header, and the audio data in G729 format is transmitted from the network I/F 21 to the telephone terminal 32. Note that UDP data can be added by the processor 22.

The audio packet storing section 23 also stores an audio packet management table for managing the audio packets stored therein. FIG. 2 is a view showing an example of the contents of the audio packet management table. The audio packet management table shown in FIG. 2 presents recipient identification information, sender identification information, encoding format classification information, and packet identification information in a manner in which correspondence relation thereof is shown.

The “recipient identification information” is information indicating the telephone terminal 32 by which audio data is received (played back), and is, for example, a telephone number. When the receiving-side telephone terminal 32 indicated by the recipient identification information transmits to the voice mail device 20 information requesting the transmission of an audio packet stored in the audio packet storing section 23, the voice mail device 20 transmits the stored audio packet thereto. As a result, audio data (voice mail) stored in the audio packet storing section 23 is played back, so that the contents of a message can be confirmed.

The “sender identification information” is information indicating the telephone terminal 32 from which audio data is transmitted (recorded), and is, for example, a telephone number. When communication with the telephone terminal 32 of the other party of its call is not started (for example, when the other party is absent or the line thereof is busy), the transmitting-side telephone terminal 32 indicated by the sender identification information transmits a message or the like as an audio packet to the voice mail device 20 to have the audio packet stored in the audio packet storing section 23, so that the other party will be able to confirm it later.

The “encoding classification information” is information for identifying the classification (G711, G729, G723.1 and the like) of the encoding format of the audio data of the audio packet stored in the audio packet storing section 23. The “packet identification information” is information for identifying the audio packet stored in the audio packet storing section 23. Incidentally, a series of audio data are generally divided into a plurality of audio packets, but this “audio packet identification information” only has to be able to designate a head audio packet. This is because it is usually apparent which are subsequent audio packets if the head audio packet is designated.

The first to third data transcoding sections 24 to 26 transcode audio data. Specifically, the first data transcoding section 24 transcodes encoded audio data in G711 format to encoded audio data in PCM (Pulse Code Modulation) format, or inversely, encoded audio data in PCM format to encoded audio data in G711 format. The second data transcoding section 25 transcodes encoded audio data in G729 format to encoded audio data in PCM format, or inversely, encoded audio data in PCM format to encoded audio data in G729 format. The third data transcoding section 26 transcodes encoded audio data in G723.1 format to encoded audio data in PCM format, or inversely, encoded audio data in PCM format to encoded audio data in G723.1 format.

Here, the encoded audio data in G711 format, the encoded audio data in G729 format, and the encoded audio data in G723.1 format are inputted/outputted via a packet bus 28 as audio packets. Further, the encoded audio data in PCM format are inputted/outputted via a PCM bus 29.

The first, second, and third data transcoding sections 24 to 26 convert the encoding format when the encoding format of the audio data included in the audio packet stored in the audio packet storing section 23 is different from the encoding format of audio data included in an audio packet to be transmitted. For example, when the audio data included in the audio packet stored in the audio packet storing section 23 is in G729 encoding format and the audio data included in the audio packet to be transmitted from the network I/F 21 is in G723.1 encoding format, the encoding format is converted.

The following is an example of the conversion at this time. The processor 22 separates the encoded audio data in G729 format from the audio packet stored in the audio packet storing section 23. The separated encoded audio data in G729 format is inputted to the second data transcoding section 25 via the packet bus 28 to be transcoded to encoded audio data in PCM format, which is outputted to the PCM bus 29. The encoded audio data in PCM format resulting from the transcoding is inputted from the PCM bus 29 to the third data transcoding section 26 to be transcoded to encoded audio data in G723.1 format, which is outputted to the packet bus 28. The processor 22 adds an RTP header and UDP processing data to the encoded audio data in G723.1 format resulting from the transcoding, and the resultant audio data is transmitted to the telephone terminal 32 from the network I/F 21.

The audio data storing section 27 is constituted of a storage means such as a hard disk or a semiconductor memory, and it stores audio data in various encoding formats. For example, the audio data storing section 27 stores audio data having the same contents as encoded audio data in G711 format, encoded audio data in G729 format, and encoded audio data in G723.1 format. The audio data having the same contents are thus stored as audio data in different encoding formats, which eliminates a need for transcoding upon transmission, so that quick data transmission is made possible.

The audio data stored in the audio data storing section 27 can be used in offering a service voice from the voice mail device 20 to the telephone terminal 32. Examples of the contents of this service voice are notification of the absence or the like of the other party of a call, notification of offering a message service by voice mail, prompting of speech, notification of the completion of recording, and so on.

The audio data stored in the audio data storing section 27 can be also used as audio data for normal voice mail besides being used as the service voice. Further, the audio data storing section 27 is capable of storing the audio data (voice mail for message or the like) transcoded by the first, second, and third data transcoding sections 24 to 26. As a result, re-transcoding is not required when the transcoded and transmitted audio data is re-transmitted, so that quick service can be offered.

The audio data to be stored in the audio data storing section 27 can be transmitted from the telephone terminals 32. For example, the telephone terminal 32 transmits an audio packet including UDP, an RTP header, and encoded audio data. Audio data in different encoding formats having the same contents (encoded audio data in G711 format, encoded audio data in G729 format, and encoded audio data in G723.1 format) can be transmitted from the telephone terminal 32. An audio packet including UDP, an RTP header, and encoded audio data may be transmitted from the input device 33 to be stored in the audio data storing section 27 as audio data.

(Operation of the Telephone System 10)

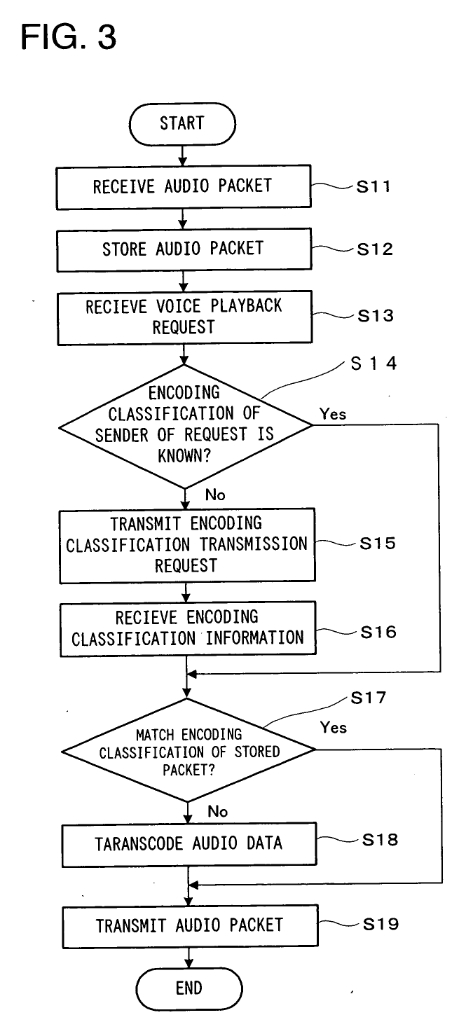

Hereinafter, the operation of the telephone system 10 will be described. FIG. 3 is a flowchart showing an example of the operation procedure of the telephone system 10. Note that the operation of the voice mail device 20 is focused on in this drawing. (1) The voice mail device 20 receives an audio packet transmitted from the telephone terminal 32 (Step S11).

The audio packet transmitted here is transmitted as voice mail for a message or the like. The purpose of this transmission is, for example, to record an audio message in the voice mail device 20 when an attempted call from one of the telephone terminals 32 to another telephone terminal 32 is not answered by the receiving-side telephone terminal 32 and thus the call cannot be connected.

Generally, the transmitting-side telephone terminal 32 is notified prior to this recording that the other party (the receiving-side telephone terminal 32) does not answer, and speech for an audio message is prompted. Voice uttered through the transmitting-side telephone terminal 32 in response to this message is transmitted to the voice mail device 20 as an audio packet. Incidentally, the audio data stored in the audio data storing section 27 can be used for prompting the speech or the like.

(2) The audio packet received by the network I/F 21 of the voice mail device 20 is stored in the audio packet storing section 23 without undergoing any audio data transcoding (Step S12). At this time, the audio packet management table is updated appropriately.

(3) The receiving-side telephone terminal 32, noticing that there is voice mail addressed to itself, transmits a voice playback request for requesting the playback of the voice mail (Step S13). The voice mail device 20 receives this voice playback request. The presence of the voice mail can be notified, for example, in such a manner that the voice mail device 20 transmits information for instructing a lamp of the telephone terminal 32 to blink, and the lamp of the telephone terminal 32 blinks according to the instruction.

(4) If an audio encoding format usable in the telephone terminal 32 transmitting the voice playback request is not known, the voice mail device 20 transmits to the telephone terminal 32 as the sender of the request an encoding classification transmission request for requesting the notification of the audio encoding format usable in this telephone terminal 32 (Steps S14 and S15). In other words, CODEC negotiation is started. (5) In response to this request, encoding classification information indicating the usable audio encoding format is transmitted from the telephone terminal 32 as the sender of the request, and is received by the voice mail device 20 (Step S16).

(6) When the audio encoding format of the audio packet (voice mail) stored in the audio packet storing section 23 matches the audio encoding format usable in the telephone terminal 32 as the sender of the request, the audio packet stored in the audio packet storing section 23 is transmitted as it is (Steps S17 and S19). When these audio encoding formats do not match each other, the first, second, and third data transcoding sections 24 to 26 perform transcoding to the audio encoding format usable in the telephone terminal 32 as the sender of the request (Step S18).

The audio packet thus transmitted from the voice mail device 20 is received by the telephone terminal 32, and then an audio message is played back. Note that the audio data thus transcoded and transmitted can be stored in the audio data storing section 27. This enables the transmission without any conversion of the audio encoding format when a voice playback request for the same audio data is given from the telephone terminal 32, so that quicker service can be offered.

(7) If the audio encoding format usable in the telephone terminal 32 as the sender of the audio playback request is known at Step S14, an audio packet including audio data in this audio encoding format is transmitted. This applies to a case, for example, where the voice mail device 20 holds a table showing correspondence relation between terminal identification information (for example, a telephone number) for identifying the telephone terminal 32 and the audio encoding format usable in this telephone terminal 32. Note that an audio packet can be transmitted, using RTP (Real-time Transport Protocol). It is also possible to transmit audio data as a file, instead of using the RTP. In this case, the “voice playback request” at Step S13 means a “file transfer request”.

### Other Embodiments

Embodiments of the present invention are not limited to the above-described embodiments, but any expansion and modification can be made therein, and expanded and modified embodiments are also included in the technical scope of the present invention.

What is claimed is:

1. A voice mail device comprising:
a receiving section which receives from a first telephone terminal an audio packet including audio data in a first encoding format;
a packet storing section which stores the audio packet including the audio data in the first encoding format received by said receiving section; and
a transmitting section which transmits to a second telephone terminal the audio packet stored in said packet storing section.

2. The voice mail device as set forth in claim 1, further comprising
an encoding format determining section which communicates with the second telephone terminal to determine an encoding format of audio data,
wherein said transmitting section transmits to the second telephone terminal the stored audio packet when the determined encoding format is the first encoding format.

3. The voice mail device as set forth in claim 1, further comprising:
an encoding format determining section which communicates with the second telephone terminal to determine an encoding format of audio data; and
a transcoding section which transcodes the audio data included in the audio packet stored in said packet storing section, based on the determination by said encoding format determining section.

4. The voice mail device as set forth in claim 3, further comprising:
a transcoded audio storing section which stores audio data transcoded by said transcoding section;
a packet converting section which converts the transcoded audio data stored in said transcoded audio storing section to an audio packet; and
a packet transmitting section which transmits to the second telephone terminal the audio packet resulting from the conversion by said packet converting section.

5. The voice mail device as set forth in claim 1, further comprising:
a first audio data storing section which stores the audio data in the first encoding format;
a second audio data storing section which stores the audio data in a second encoding format;
an encoding format determining section which communicates with the second telephone terminal to determine an encoding format of audio data;
an audio data selecting section which selects the audio data stored in one of said first and second audio data storing sections based on the determination by said encoding format determining section;
a packet converting section which converts the audio data selected by said audio data selecting section to an audio packet; and
a packet transmitting section which transmits the audio packet resulting from the conversion by said packet converting section.

6. The voice mail device as set forth in claim 5, further comprising
a packet receiving section which receives a first audio packet including the audio data in the first encoding format and a second audio packet including the audio data in the second encoding format,
wherein said first and second audio data storing sections store the first and second audio data included in the first and second audio packets received by said packet receiving section.

7. The voice mail device as set forth in claim 6, wherein said packet receiving section receives the first and second audio packets transmitted from a telephone terminal.

8. The voice mail device as set forth in claim 6, wherein said packet receiving section receives first and second audio packets originating in audio data recorded in a storage medium.

9. A voice mail communication method, comprising:
receiving from a first telephone terminal an audio packet including audio data in a first encoding format;
storing the received audio packet including the audio data in the first encoding format; and
transmitting the stored audio packet to a second telephone terminal.

10. The voice mail communication method as set forth in claim 9, further comprising
communicating with the second telephone terminal to determine an encoding format of audio data,
wherein the stored audio packet is transmitted to the second telephone terminal when the determined encoding format is the first encoding format.

11. The voice mail communication method as set forth in claim 9, further comprising:
communicating with the second telephone terminal to determine an encoding format of audio data; and
transcoding the audio data included in the stored audio packet, based on the determined encoding format.

12. The voice mail communication method as set forth in claim 11, further comprising:
storing the transcoded audio data;
converting the stored transcoded audio data to an audio packet; and
transmitting the audio packet resulting from the conversion to the second telephone terminal.

13. The voice mail communication method as set forth in claim 9, further comprising:
storing the audio data in the first encoding format;
storing the audio data in a second encoding format;
communicating with the second telephone terminal to determine an encoding format of audio data;
selecting the stored audio data in one of the first and second encoding formats based on the determined encoding format;
converting the selected audio data to an audio packet; and
transmitting the audio packet resulting from the conversion.

14. The voice mail communication method as set forth in claim 13, further comprising
receiving a first audio packet including the audio data in the first encoding format and a second audio packet including the audio data in the second encoding format,
wherein the stored audio data in the first and second encoding formats are the audio data in the first and second encoding formats included in the received first and second audio packets.

15. The voice mail communication method as set forth in claim 14, wherein the received first and second audio packets are transmitted from a telephone terminal.

16. The voice mail communication method as set forth in claim 14, wherein the received first and second audio packets originate in audio data recorded in a storage medium.
